(19) United States
(12) Patent Application Publication
(10) Pub. No.: US 2016/0035344 A1
(43) Pub. Date: Feb. 4, 2016

(54) IDENTIFYING THE LANGUAGE OF A SPOKEN UTTERANCE

(71) Applicant: Google Inc., Mountain View, CA (US)

(72) Inventors: Javier Gonzalez-Dominguez, Madrid (ES); Hasim Sak, New York, NY (US); Ignacio Lopez Moreno, New York, NY (US)

(21) Appl. No.: 14/817,302

(22) Filed: Aug. 4, 2015

Related U.S. Application Data
(60) Provisional application No. 62/032,938, filed on Aug. 4, 2014.

(51) Int. Cl. G10L 15/00

(52) U.S. Cl. CPC G10L 15/005

(57) ABSTRACT

Methods, systems, and apparatus, including computer programs encoded on computer storage media, for identifying the language of a spoken utterance. One of the methods includes receiving a plurality of audio frames that collectively represent at least a portion of a spoken utterance; processing the plurality of audio frames using a long short term memory (LSTM) neural network to generate a respective language score for each of a plurality of languages, wherein the respective language score for each of the plurality of languages represents a likelihood that the spoken utterance was spoken in the language; and classifying the spoken utterance as being spoken in one of the plurality of languages using the language scores.

### CROSS REFERENCE TO RELATED APPLICATION

This application claims the benefit of U.S. Provisional Application No. 62/032,938, filed Aug. 4, 2014, the contents of which are herein incorporated by reference.

### BACKGROUND

This specification relates to identifying the language of a spoken utterance.

Speech-to-text systems can be used to generate a textual representation of a verbal utterance. Speech-to-text systems typically attempt to use various characteristics of human speech, such as the sounds produced, rhythm of speech, and intonation, to identify the words represented by such characteristics. Many speech-to-text systems are configured to only recognize speech in a single language or to require a user to manually designate which language the user is speaking.

### SUMMARY

In general, one innovative aspect of the subject matter described in this specification can be embodied in methods that include the actions of receiving a plurality of audio frames that collectively represent at least a portion of a spoken utterance; processing the plurality of audio frames using a long short term memory (LSTM) neural network to generate a respective language score for each of a plurality of languages, wherein the respective language score for each of the plurality of languages represents a likelihood that the spoken utterance was spoken in the language; and classifying the spoken utterance as being spoken in one of the plurality of languages using the language scores.

Particular embodiments of the subject matter described in this specification can be implemented so as to realize one or more of the following advantages. The language in which an utterance was spoken can be accurately predicted by a language identification system. By using an LSTM neural network, the language identification system can be trained quicker and deployed more easily than other language identification systems. For example, by using an LSTM neural network, the language identification system can receive smaller inputs, e.g., audio frames without stacking, and have a smaller number of parameters while still generating accurate results. By using an LSTM neural network, the sequence of language scores for a given language generated by the language identification system while processing an utterance can be smoother, i.e., with less variation between scores. In some implementations, the language identification system can increase the accuracy of predictions by effectively combining the predictions generated by the language identification system with predictions generated by one or more other language identification systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example language identification system.

FIG. 2 is a flow diagram of an example process for classifying an utterance as being spoken in a particular language.

FIG. 3 is a flow diagram of an example process for selecting a language using multiple language scores.

Like reference numbers and designations in the various drawings indicate like elements.

### DETAILED DESCRIPTION

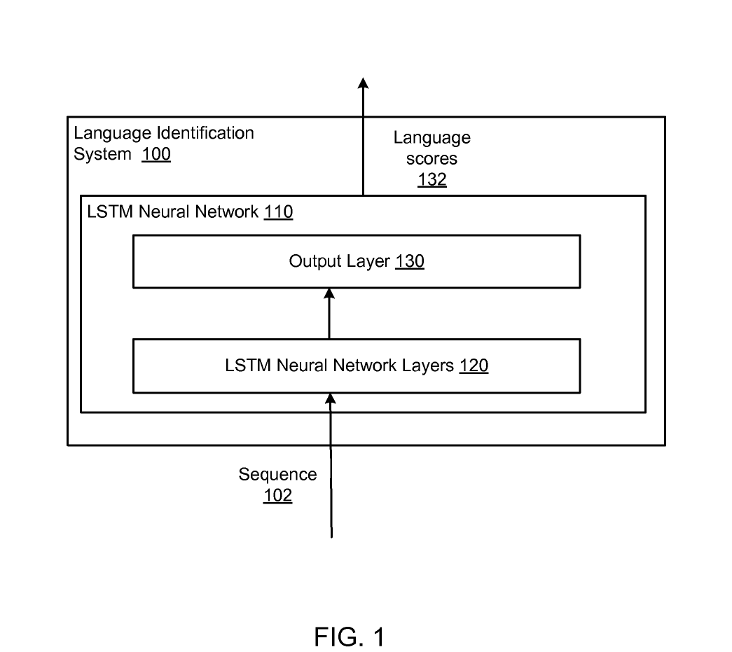

FIG. 1 shows an example language identification system 100. The language identification system 100 is an example of a system implemented as computer programs on one or more computers in one or more locations, in which the systems, components, and techniques described below can be implemented.

The language identification system 100 receives a sequence of audio frames that collectively represent a spoken utterance and processes the audio frames in the sequence to classify the utterance as being spoken in one of a predetermined set of languages. In particular, the language identification system 100 processes each audio frame in the sequence using a long short term memory (LSTM) neural network 110 to generate a respective language score for each language in the set of languages. The language score for a given language represents a likelihood that the given language is the language in which the utterance represented by the sequence of audio frames was spoken. For example, the language identification system 100 can receive a sequence of audio frames 102 that represents an utterance and generate language scores 132 for the sequence 102.

The LSTM neural network 110 includes one or more LSTM neural network layers 120 and an output layer 130.

For each audio frame in an input sequence, the one or more LSTM neural network layers 120 are configured to process the audio frame to collectively generate an LSTM output for the audio frame. Each LSTM neural network layer includes one or more LSTM memory blocks. Each LSTM memory block can include one or more cells that each include an input gate, a forget gate, and an output gate that allow the cell to store previous activations generated by the cell, e.g., for use in generating a current activation or to be provided to other components of the LSTM neural network 110. Example LSTM neural network layers are described in more detail in “Supervised Sequence Labelling with Recurrent Neural Networks,” Alex Graves, Dissertation, Technische Universität München, München, 2008, available at http://www.cs.toronto.edu/˜graves/phd.pdf.

The output layer 130 has been configured, e.g., through training, to, for each audio frame, receive the LSTM output generated by the one or more LSTM neural network layers 120 for the audio frame and to process the LSTM output to generate a set of frame scores that includes a respective frame score for each of the languages in the predetermined set of languages. The frame score for a given language represents the likelihood that the portion of the spoken utterance represented by the audio frame was spoken in the given language. In some implementations, the output layer 130 is a softmax output layer.

In some implementations, the one or more LSTM neural network layers 120 are bidirectional LSTM neural network layers, so that, when generating frame scores for an audio frame in position i in a sequence that includes L audio frames, the LSTM neural network layers 120 also process the audio frame at position L−i in the sequence. The output generated by processing both the audio frame i and the audio frame L−i is provided to the output layer 130 as the LSTM output for the audio frame in position i in the sequence. Example bidirectional LSTM neural network layers are described in more detail in “HYBRID SPEECH RECOGNITION WITH DEEP BIDIRECTIONAL LSTM,” Alex Graves, Navdeep Jaitly and Abdel-rahman Mohamed, available at http://www.cs.toronto.edu/˜graves/asru_{—}2013.pdf.

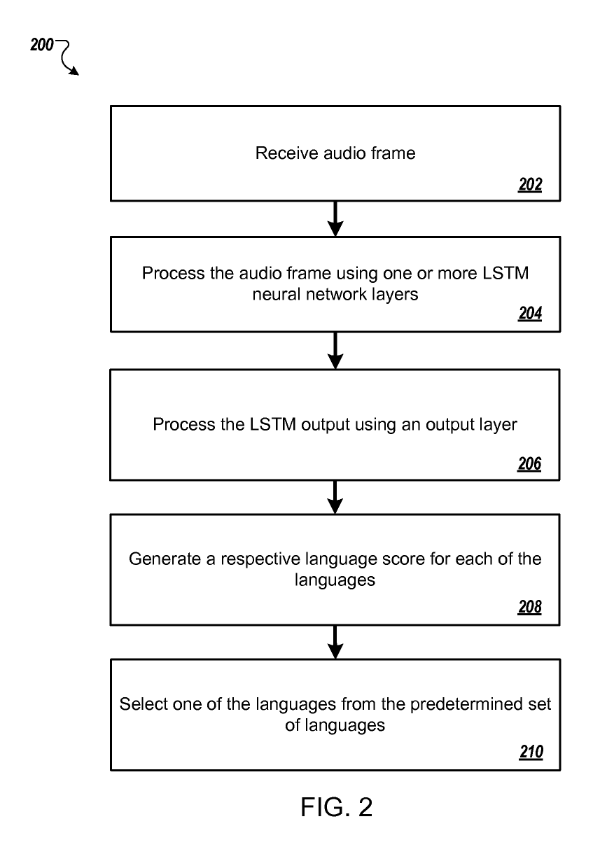

Once all of the language identification system 110 has processed all of the audio frames in the sequence using the LSTM neural network 110, the language identification system 110 determines a language score for each of the languages in the set of languages from the frame scores for the language. In particular, for a given language in the set, the language identification system 110 combines the frame scores for the language across the audio frames in the sequence to generate the language score for the given language. Generating the language score for the language is described in more detail below with reference to FIG. 2.

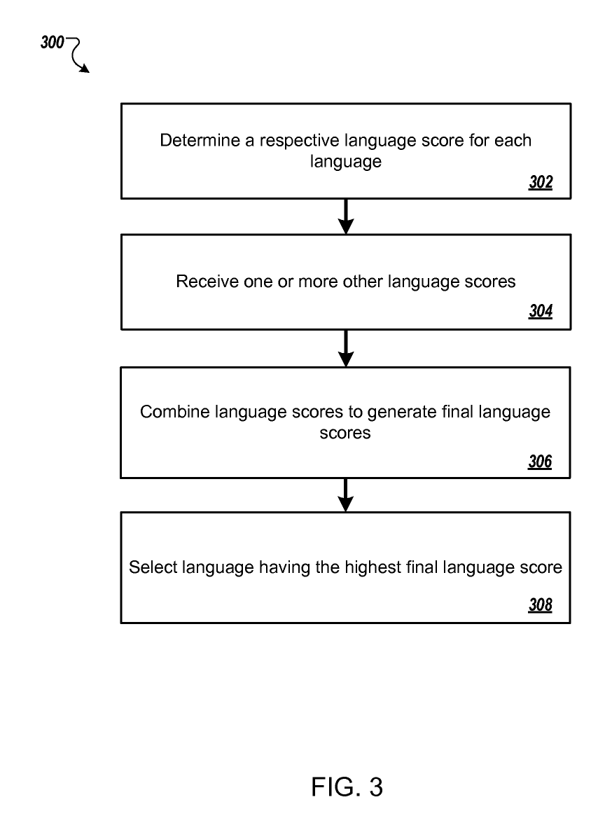

The language identification system 110 then uses the language scores to classify the utterance as being spoken in a particular language. In some implementations, the language identification system 110 selects the language having the highest language score as the language in which the utterance was spoken. In some other implementations, however, the language identification system 110 combines the language scores with one or more other language scores for each language generated by other language identification systems. That is, the language identification system 110 receives other language scores generated by other language identification systems, combines the other language scores with the language scores determined by the language identification system 100, and then uses the combined language scores to classify the utterance as being spoken in a particular language. Combining language scores is described in more detail below with reference to FIG. 3.

FIG. 2 is a flow diagram of an example process 200 for classifying an utterance as being spoken in a particular language. For convenience, the process 200 will be described as being performed by a system of one or more computers located in one or more locations. For example, a language identification system, e.g., the language identification system 100 of FIG. 1, appropriately programmed, can perform the process 200.

The system receives an audio frame from a sequence of audio frames that collectively represents an utterance (step 202). Generally, each audio frame is generated from data calculated from a given time step in the spoken utterance. In particular, because the language identification is performed using an LSTM neural network that maintains an internal state, the audio frames can be generated without any stacking of audio frames, reducing the size of the inputs to the system. For example, the audio frames can each be 39-dimensional perceptual linear predictive (PLP) features calculated at respective time steps in the utterance.

The system processes the audio frame using one or more LSTM neural network layers to generate an LSTM output for the audio frame (step 204). Each of the one or more LSTM neural network layers includes one or more LSTM memory blocks. Each LSTM memory block can include one or more cells that each include an input gate, a forget gate, and an output gate that allow the cell to store previous activations generated by the cell. The LSTM neural network layers collectively process the audio frame to generate the LSTM output in accordance with values of parameters of the LSTM neural network layers.

The system processes the LSTM output using an output layer to generate a respective frame score for each language in the predetermined set of languages (step 206). The output layer is configured to process the LSTM output to generate the respective frame scores in accordance with values of parameters of the output layer.

After the system has processed each of the audio frames in the sequence, the system generates a respective language score for each of the languages in the set of languages (step 208). In particular, the system generates the language score for a given language in the set of languages by combining the frame scores for the language. For example, the system can, for each language in the set, determine a logarithm of each of the frame scores for the language and then determine the language score for the language by averaging or otherwise combining the logarithms of the frame scores for the language. In some other implementations, the system combines the frame scores without first computing the logarithms.

The system selects one of the languages from the predetermined set of languages as the language in which the utterance was spoken using the language scores (step 210). In some implementations, system selects the language having the highest language score as the language in which the utterance was spoken. In some other implementations, the system combines the language scores with one or more other language scores for each language as described in more detail below with reference to FIG. 3.

In some implementations, rather than wait until after the system has processed each audio frame in the sequence, the system can generate the language scores as described above incrementally. For example, the system can generate the language scores after processing every i-th frame in the sequence, e.g., every frame, every other frame, or every tenth frame. In these implementations, the system can determine whether the language score for any of the language scores is high enough, i.e., exceeds a threshold score, and, if so, can select that language as the language in which the utterance was spoken. If none of the language scores is high enough, the system can continue processing the audio frames in the sequence. Thus, the system can classify the language of an utterance by processing frames that represent only a portion of the utterance.

The process 200 can be performed to predict a language for an utterance for which the desired output is not known, e.g., for a received sequence of audio frames that represent an utterance for which the spoken language has not yet been identified. The process 200 can also be performed on training sequences, i.e., sequences that represent utterance for which the spoken language has already been identified, as part of training the LSTM neural network to determine trained values of the parameters of the LSTM neural network, i.e., of parameters of the LSTM neural network layers and the output layer. In order to determine the trained values of the parameters of the LSTM neural network, the system can train the LSTM neural network on the training sequences using a conventional machine learning training technique, e.g., a truncated backpropagation through time training technique.

FIG. 3 is a flow diagram of an example process 300 for selecting a language using multiple language scores. For convenience, the process 300 will be described as being performed by a system of one or more computers located in one or more locations. For example, a language identification system, e.g., the language identification system 100 of FIG. 1, appropriately programmed, can perform the process 300.

The system determines a respective language score for each language in a predetermined set of languages, e.g., as described above with reference to FIG. 2 (step 302).

The system receives, for each language, one or more other language scores (step 304). Generally, each other language score for a given language is generated by a distinct language identification system. For example, the other language identification systems can include one or more systems that generate language scores using deep, feedforward neural networks. An example language identification system that uses a feedforward neural network is described in I. Lopez-Moreno, J. Gonzalez-Dominguez, O. Plchot, D. Martinez, J. Gonzalez-Rodriguez, and P. Moreno, “Automatic Language Identification using Deep Neural Networks,” Acoustics, Speech, and Signal Processing, IEEE International Conference 2014. As another example, the other language identification systems can include one or more i-vector language identification systems. An example i-vector language identification system is described in N. Dehak, P. A. Torres-Carrasquillo, D. A. Reynolds, and R. Dehak, “Language Recognition via i-vectors and Dimensionality Reduction,” in INTERSPEECH. ISCA, 2011, pp. 857-860.

The system combines, for each language, the language scores for the language to generate a final language score for the language (step 306). For example, the system can combine the language scores in accordance with a set of combining parameters. In some implementations, the combining parameters include one or more parameters that are specific to each language and one or more parameters that are specific to each language identification system. For example, the final language score ŝ_{L}(xₜ) for a language L for an utterance xₜ may satisfy:

$${\hat{s}}_{L} ( {x}_{t} ) = {\sum }_{k = 1}^{K} {α}_{k} {s}_{kL} ( {x}_{t} ) + {β}_{L} ,$$

where K is the total number of language identification systems, s_{kL}(xₜ) is the language score for the language L generated by the k-th language identification system, αₖ is a trained value of a combining parameter specific to the k-th language identification system, and β_{L} is the trained value of a combining parameter for the language L. The system can determine the trained values of the combining parameters by training on training utterances using conventional training techniques.

The system selects the language having the highest final language score as the language in which the utterance was spoken (step 308).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a plurality of audio frames that collectively represent at least a portion of a spoken utterance;
processing the plurality of audio frames using a long short term memory (LSTM) neural network to generate a respective language score for each of a plurality of languages, wherein the respective language score for each of the plurality of languages represents a likelihood that the spoken utterance was spoken in the language; and
classifying the spoken utterance as being spoken in one of the plurality of languages using the language scores.

2. The method of claim 1, wherein the LSTM neural network comprises one or more LSTM neural network layers and an output layer, and wherein processing the plurality of audio frames using the LSTM neural network comprises, for each of the plurality of audio frames:
processing the audio frame through each of the one or more LSTM neural network layers to generate an LSTM output for the audio frame; and
processing the audio frame through the output layer to generate a respective frame score for each of the plurality of languages for the audio frame.

3. The method of claim 2, wherein processing the plurality of audio frames further comprises:
determining the respective language score for each of the plurality of languages from the frame scores for the language for the plurality of audio frames.

4. The method of claim 3, wherein determining the respective language score for each of the plurality of languages comprises:
determining a respective logarithm of each of the frame scores for the language; and
determining an average of the respective logarithms.

5. The method of claim 1, wherein classifying the spoken utterance as having been spoken in one of the plurality of languages using the language scores comprises:
selecting a language having a highest language score as the language in which the spoken utterance was spoken.

6. The method of claim 1, wherein classifying the spoken utterance as having been spoken in one of the plurality of languages using the language scores comprises:
obtaining, for each language, one or more other language scores, each other language score generated by another language identification system;
combining, for each language, the one or more other language scores for the language and the language score for the language to generate a final language score for the language; and
selecting a language having a highest final language score as the language in which the spoken utterance was spoken.

7. The method of claim 6, wherein combining, for each language, the one or more other language scores for the language and the language score for the language comprises:
combining the other language scores and the language score in accordance with trained values of a set of combining parameters.

8. The method of claim 1, wherein the LSTM neural network has been trained using a backpropagation through time training technique.

9. A system comprising one or more computers and one or more storage devices storing instructions that when executed by the one or more computers cause the one or more computers to perform operations comprising:
receiving a plurality of audio frames that collectively represent at least a portion of a spoken utterance;
processing the plurality of audio frames using a long short term memory (LSTM) neural network to generate a respective language score for each of a plurality of languages, wherein the respective language score for each of the plurality of languages represents a likelihood that the spoken utterance was spoken in the language; and
classifying the spoken utterance as being spoken in one of the plurality of languages using the language scores.

10. The system of claim 9, wherein the LSTM neural network comprises one or more LSTM neural network layers and an output layer, and wherein processing the plurality of audio frames using the LSTM neural network comprises, for each of the plurality of audio frames:
processing the audio frame through each of the one or more LSTM neural network layers to generate an LSTM output for the audio frame; and
processing the audio frame through the output layer to generate a respective frame score for each of the plurality of languages for the audio frame.

11. The system of claim 10, wherein processing the plurality of audio frames further comprises:
determining the respective language score for each of the plurality of languages from the frame scores for the language for the plurality of audio frames.

12. The system of claim 11, wherein determining the respective language score for each of the plurality of languages comprises:
determining a respective logarithm of each of the frame scores for the language; and
determining an average of the respective logarithms.

13. The system of claim 9, wherein classifying the spoken utterance as having been spoken in one of the plurality of languages using the language scores comprises:
selecting a language having a highest language score as the language in which the spoken utterance was spoken.

14. The system of claim 9, wherein classifying the spoken utterance as having been spoken in one of the plurality of languages using the language scores comprises:
obtaining, for each language, one or more other language scores, each other language score generated by another language identification system;
combining, for each language, the one or more other language scores for the language and the language score for the language to generate a final language score for the language; and
selecting a language having a highest final language score as the language in which the spoken utterance was spoken.

15. The system of claim 14, wherein combining, for each language, the one or more other language scores for the language and the language score for the language comprises:
combining the other language scores and the language score in accordance with trained values of a set of combining parameters.

16. The system of claim 9, wherein the LSTM neural network has been trained using a backpropagation through time training technique.

17. A computer program product encoded on one or more non-transitory computer storage media, the computer program product comprising instructions that when executed by one or more computers cause the one or more computers to perform operations comprising:
receiving a plurality of audio frames that collectively represent at least a portion of a spoken utterance;
processing the plurality of audio frames using a long short term memory (LSTM) neural network to generate a respective language score for each of a plurality of languages, wherein the respective language score for each of the plurality of languages represents a likelihood that the spoken utterance was spoken in the language; and
classifying the spoken utterance as being spoken in one of the plurality of languages using the language scores.

18. The computer program product of claim 17, wherein the LSTM neural network comprises one or more LSTM neural network layers and an output layer, and wherein processing the plurality of audio frames using the LSTM neural network comprises, for each of the plurality of audio frames:
processing the audio frame through each of the one or more LSTM neural network layers to generate an LSTM output for the audio frame; and
processing the audio frame through the output layer to generate a respective frame score for each of the plurality of languages for the audio frame.

19. The computer program product of claim 18, wherein processing the plurality of audio frames further comprises:
determining the respective language score for each of the plurality of languages from the frame scores for the language for the plurality of audio frames.

20. The computer program product of claim 17, wherein classifying the spoken utterance as having been spoken in one of the plurality of languages using the language scores comprises:
selecting a language having a highest language score as the language in which the spoken utterance was spoken.
